(19) United States
(12) Patent Application Publication
(10) Pub. No.: US 2009/0161978 A1
(43) Pub. Date: Jun. 25, 2009

(54) Halo Artifact Removal Method

(76) Inventor: Marinko Karanovic, Markham (CA)

Correspondence Address: MCANDREWS HELD & MALLOY, LTD, 500 WEST MADISON STREET, SUITE 3400, CHICAGO, IL, 60661, US

(21) Appl. No.: 11/960,991

(22) Filed: Dec. 20, 2007

(51) Int. Cl. G06K 9/40

(52) U.S. Cl. 382/260

(57) ABSTRACT

A system for performing frame rate conversion of a video signal including a plurality of video frames. The system includes a projection generator adapted and configured to generate a forward projection pixel map from a first video frame and generate a backwards projection pixel map from a second video frame. A pixel kernel selector is adapted and configured to select a first kernel of pixels from the forward projection pixel map and to select a second kernel of pixels from the backwards projection pixel map that is co-sited with the first kernel. A median filter engine is adapted and configured to perform median filtering on the first and second pixel kernels and to generate a filter value. A processor adapted and configured to determine the minimum error value of a group of a forward error value, a backward error value, and a average error value, and select an output pixel value that corresponds to a minimum error value.

### BACKGROUND

1. Technical Field of the Invention

The invention relates to a method and a device for motion estimation, and to a video display apparatus comprising a motion compensated interpolation device.

2. Description of the Prior Art

Traditionally, motion estimation algorithms suffer from problems related to occlusions, where elements disappear and re-appear as objects move across the field of view over consecutive frames. The occlusions cause annoying artifacts known as halo around foreground objects. Additionally, in some applications, there is a concern over the computational cost of motion estimation. Most known motion compensated frame rate conversion algorithms used to reduce the halo artifact rely on correcting incorrect vectors in the occlusion areas. These methods are costly in terms of memory bandwidth and computation time since the algorithms must re-calculate the motion vectors to correct and remove the errors in occlusion areas.

### SUMMARY

In general, in an aspect, the invention provides a system for performing frame rate conversion of a video signal including a plurality of video frames, the system comprising at least one projection generator adapted and configured to generate a forward projection pixel map from a first video frame and generate a backwards projection pixel map from a second video frame, a pixel kernel selector adapted and configured to select a first kernel of pixels from the forward projection pixel map and to select a second kernel of pixels from the backwards projection pixel map that is co-sited with the first kernel, a median filter engine adapted and configured to perform median filtering on the first and second pixel kernels and to generate a filter value, and a processor adapted and configured to determine: a forward error value as a function of the filter value and a pixel value of the first kernel, a backward error value as a function of the filter value and a pixel value of the second kernel, and an average error value as a function of the filter value and an average pixel value of the first and second kernels, wherein the processor is further configured to: determine the minimum error value of the group of the forward error value, the backward error value, and the average error value, and select an output pixel value that corresponds to the minimum error value.

Implementations of the invention may include one or more of the following features. The at least one projection generator comprises a first projection generator configured to generate a forward projection pixel map from a first video frame and a second projection generator configured to generate a backwards projection pixel map from a second video frame. The median filter engine is further configured to perform two dimensional median filtering on the first and second pixel kernels. The pixel value of the first kernel comprises the center pixel of the first kernel and the pixel value of the second kernel comprises the center pixel of the second kernel. The system comprises computer readable media storing instructions in a hardware description language software. The system, wherein the instructions comprise at least one of: Verilog hardware description language software, Verilog-A hardware description language software, and VHDL hardware description language software.

In general, in another aspect, the invention provides a method for performing frame rate conversion of a video signal including a plurality of video frames, the method comprising: generating a forward projection pixel map from a first video frame, generating a backwards projection pixel map from a second video frame, selecting a first kernel of pixels in the forward projection pixel map, selecting a second kernel of pixels in the backward projection pixel map that is co-located with the first kernel, implementing a rank-order filter to the first and second kernels and generating a filter value, determining a forward error value as a function of the filter value and a pixel value from the first kernel, determining a backward error value as a function of the filter value and a pixel value from the second kernel, determining an average error value as a function of the filter value and an average pixel value from the first and second kernel, determining the minimum error value of the group of the forward error value, the backward error value, and the average error value, and outputting the pixel value that corresponds to the minimum error value.

Implementations of the invention may include one or more of the following features. Implementing a rank-order filter includes implementing a two dimensional median filter. The pixel value of the first kernel comprises the center pixel of the first kernel and the pixel value of the second kernel comprises the center pixel of the second kernel.

In general, in another aspect, the invention provides a computer readable media storing instructions, said instructions when executed are adapted to generate a forward projection pixel map from a first video frame, generate a backwards projection pixel map from a second video frame, select a first kernel of pixels in the forward projection pixel map, select a second kernel of pixels in the backward projection pixel map that is co-located with the first kernel, implement a rank-order filter to the first and second kernels and generating a filter value, determine a forward error value as a function of the filter value and a pixel value from the first kernel, determine a backward error value as a function of the filter value and a pixel value from the second kernel, determine an average error value as a function of the filter value and an average pixel value from the first and second kernel, determine the minimum error value of the group of the forward error value, the backward error value, and the average error value, and output the pixel value that corresponds to the minimum error value.

Implementations of the invention may include one or more of the following features. Instructions comprise instructions in a hardware description language software. The instructions in a hardware description language comprise at least one of: Verilog hardware description language software, Verilog-A hardware description language software, and VHDL hardware description language software.

In general, in another aspect, the invention provides a system for performing frame rate conversion of a video signal including a plurality of video frames, the system comprising a median filter engine to perform median filtering on first and second pixel kernels and to generate a filter value, the first kernel pixels selected from a forward projection pixel map based on a first video frame and the second kernel of pixels selected from a backwards projection pixel map that is co-sited with the first kernel and the backwards projection pixel map based on a second video frame, and a processor to select an output pixel value based on a minimum error value generated from said filter value, pixel values of said first and second kernels.

Implementations of the invention may include one or more of the following features. The median filter engine is further configured to perform two dimensional median filtering on the first and second pixel kernels. The pixel value of the first kernel comprises the center pixel of the first kernel and the pixel value of the second kernel comprises the center pixel of the second kernel. The system includes computer readable media storing instructions in a hardware description language software. The instructions comprise at least one of: Verilog hardware description language software, Verilog-A hardware description language software, and VHDL hardware description language software.

In general, in another aspect, the invention provides a method of performing frame rate conversion of a video signal including a plurality of video frames, the method comprising generating a filter value based on a spatial selection of corresponding pixels in first and second projections, the first projection corresponding at least in part on a motion compensated frame for an intermediate time generated from a first frame, the second projection corresponding at least in part on a motion compensated frame for the intermediate time generated from a second frame generating a pixel value from one of: a first pixel in the first projection, a second pixel in the second projection, or a combination of the first and second pixels, the generating based in part on said filter value.

Implementations of the invention may include one or more of the following features. Generating a filter value includes implementing a two dimensional median filter. The first pixel of the first projection comprises a center pixel of the spatial selection in the first projection and the second pixel of the second projection comprises a center pixel of the spatial selection in the second projection.

A method and apparatus are provided to efficiently remove halo artifacts from motion compensated frame rate converted video images by performing a median filter on two kernels of pixels for the same dimensional area of an image from different sources (e.g. frames), and then outputting the pixel from the source with the least error to the median value or the average of the sources if it is the same as the median (i.e. no error or occlusion).

In accordance with implementations of the invention, one or more of the following capabilities may be provided. A halo removal algorithm may be provided that requires relatively small computational overhead and memory requirements. A halo removal algorithm may be provided that does not require the correction of vector fields.

These and other capabilities of the invention, along with the invention itself, will be more fully understood after a review of the following figures, detailed description, and claims.

### BRIEF DESCRIPTION OF THE FIGURES

FIG. 1 is a diagrammatic view of a halo removal algorithm control path according to the invention.

FIG. 2 is a flow diagram of a halo removal method according to the invention.

FIG. 3 is an illustration of a halo removal method according to the embodiment shown in FIG. 2.

FIG. 4 is an illustration of exemplary kernel sizes on pixel maps.

FIG. 5 is a block diagram of an exemplary embodiment of the system.

FIG. 6 is a block diagram of another exemplary embodiment of the system.

### DETAILED DESCRIPTION

Embodiments of the invention provide methods and systems for efficiently removing halo artifacts in a video image frame rate conversion system. Exemplary embodiments of the invention include one or more processors, a projection generator, a pixel kernel selector, and a median filter engine. The projection generator uses motion compensation vectors to project image frame pixel data from two source frames to a common interpolated frame position. The pixel kernel selector then selects, from the same corresponding spatial location, two N×N kernels from the two image frame pixel projections. The median filter engine combines the two kernels into a single sorted list and determines the median filter value. The median filter value is used as a control value input to the processor to determine which one of the first projection pixel, the second projection pixel, or the average (or other combination) of the pixels is output to the display as part of the interpolated frame.

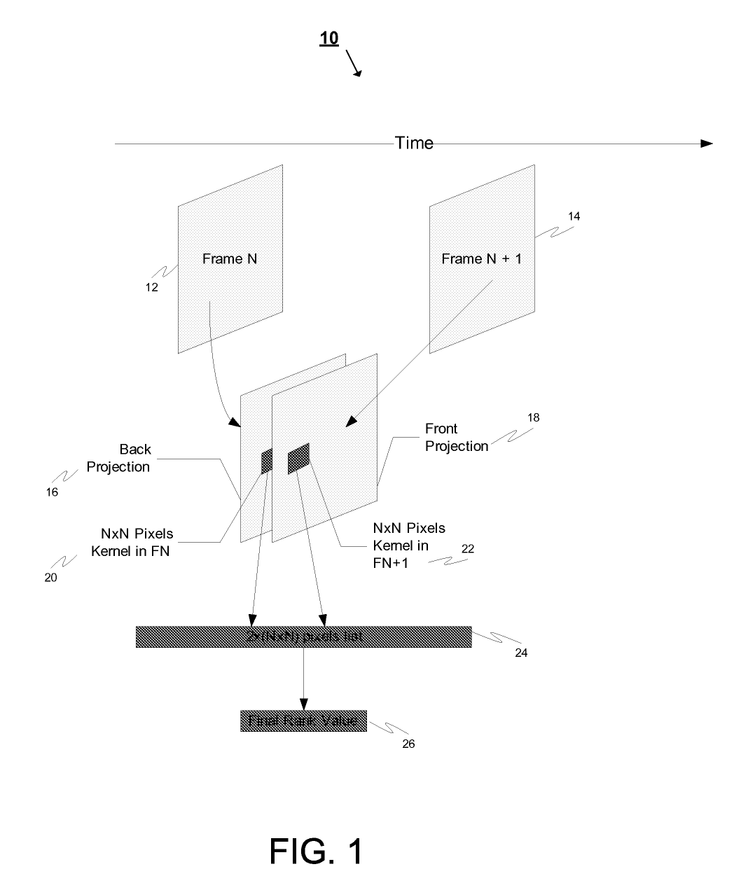

Referring to FIG. 1, a halo removal method and system embodying aspects of the invention 10 includes a first image frame (N) 12, a subsequent image frame (N+1) 14, a back projection 16, a front projection 18, a first kernel of pixels 20 selected from the back projection 16, a second kernel of pixels 22 selected from the front projection 18, a median filter 24, and a median filter control value 26. The halo removal method and system 10 is configured to generate image frame pixel projections, select pixel kernels from the projections, input the pixel kernels to a filter, and generate a control value from which a decision is made upon which motion compensated pixel value is to be output to the display for an interpolated frame. The digital video image stream comprises a plurality of video image frames that are received at a video display device in a sequence over a time period.

In accordance with an embodiment of the invention, the image frame (N) 12 represents a video image at a first instance in time. This image frame 12 is a complete pixel map that is capable of being displayed to a viewer. The image frame (N+1) 14 represents the video image in a subsequent instance (N+1) in time. This image frame (N+1) 14 is also a complete pixel map that is capable of being displayed to a viewer. The image frame (N) 12 is used as source with motion compensation vectors to generate a back projection 16 of the pixel values as they would appear at some intermediate time (e.g. N+1/2). The image frame (N+1) 14 is used as a source with motion compensation vectors to generate a front projection 18 of the pixel values as they would appear at the same intermediate time as the back projection (e.g. N+1/2). While two source frames 12, 14 are shown in FIG. 1, more frames can be used to generate each projection. Depending on the specific images and relative motions of objects in the images, the projections 16, 18 may have incorrect pixel values due to incorrect motion vectors which may be caused by areas of occlusion in the image motion sequences. In alternative embodiments image fields can be used for frames.

The errors due to incorrect motion vectors in the occlusion areas around a moving foreground object (e.g. a baseball) are complimentary. This means that in the N+1/2 position of time, the ball (if it is moving left to right across the image) could have errors (and thus halos) both on its left side and its right side. The left side errors/halo comes from the back projection/previous frame (N) in time where the reference source frame has no information about the uncovered background for the pixel values. The right side errors/halo comes from the front projection/subsequent frame (N+1) in time where the reference source frame has no information about the uncovered background pixel values. The error from the subsequent (N+1) frame is on the right side due to the fact of the relative motion of the ball is right to left as time is shifted back from (N+1) to (N+1/2).

In accordance with an embodiment of the invention, a first kernel of pixels 20 is selected from the back projection 16. A kernel is a set or group of pixels in an N×N structure and does not need to be square in shape (e.g. 6×6). There are no restrictions on the size of the kernel, but preferably it should be larger than a 1×1 kernel. Although in this embodiment the kernel size is shown as a N×N matrix structure, a preferred embodiment uses a 5×3 kernel. One of the reasons for the use of a non-square kernel that is wider than it is tall is that a majority of motion in a typical video sequence is dominantly horizontal. This has the corresponding effect that horizontal displacement is larger and perceptually more important. The kernel size/shape can be selected to take this horizontal importance into account. Kernel size/shape can also be determined based on the quality of the estimated motion-vector field. A smaller kernel size can be used when the estimated motion field tracks object boundaries well and a good estimate results in few errors or halos. The current preferred embodiment size of 5×3 has been determined empirically by regressing over a reference set of video clips.

A second kernel of pixels 22 is selected from the same corresponding spatial location in the front projection 18 as the first kernel 20 is from in the back projection 16.

The median filter 24 is configured and disposed to receive the contents of the first and second pixel kernels 20, 22. The median filter 24 can be a two dimensional median filter (e.g. vertical and horizontal of the kernel). The median filter 24 combines the contents of the two kernels into a single list. The median filter 24 generates the average of the two values that are closest to the median of the combined list to be output as the median filter control value 26. The control value 26 is input to a processor to determine which one of a front projection pixel, a back projection pixel, or the average of the pixels is output to a display as part of an interpolated frame.

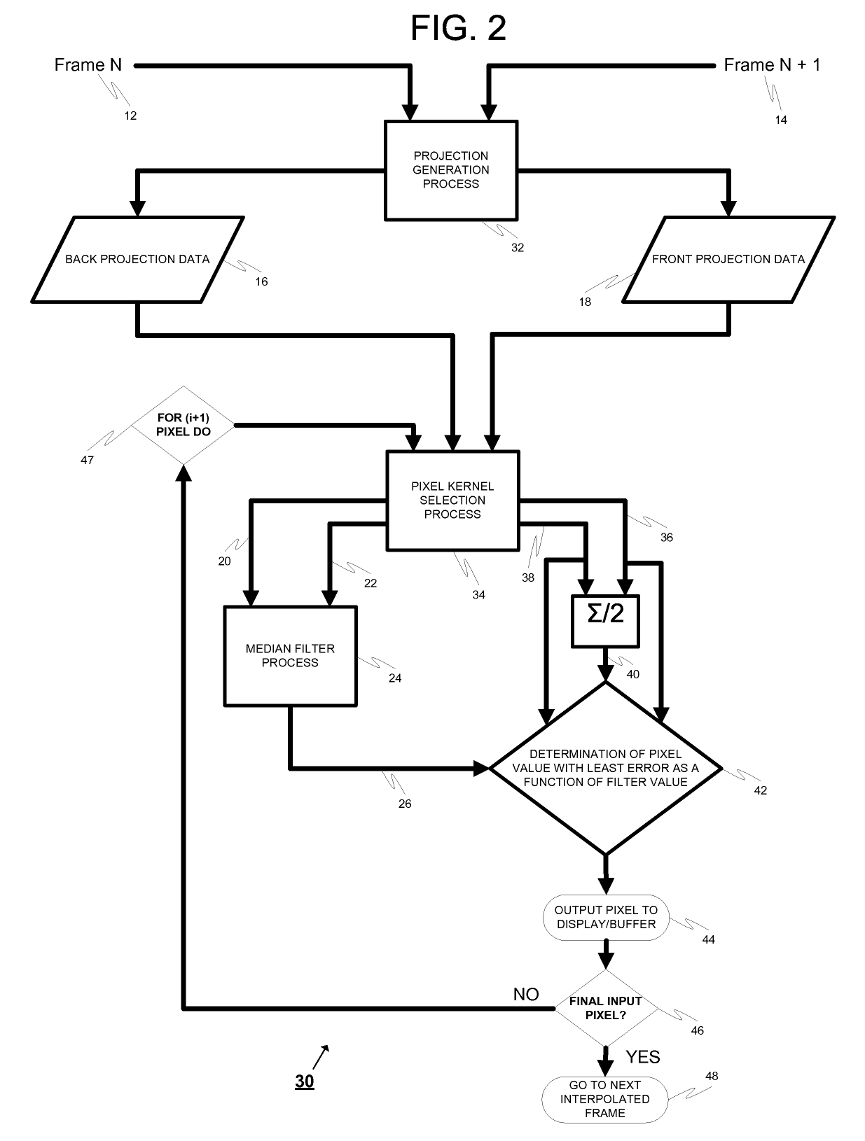

Referring to FIG. 2, a halo removal process 30 according to an embodiment of the present invention includes an image frame (N) 12, an image frame (N+1) 14, a back projection 16, a front projection 18, a first kernel of pixels 20, a second kernel of pixels 22, a median filter 24, a median filter control value 26, a projection generation process 32, a pixel kernel selection process 34, a front projection pixel value 36, a back projection pixel value 38, an average of the front and back projection pixel values 40, a determination process 42, and an output pixel value 44.

The two image frames (N) and (N+1) 12, 14 are the same that are used in the algorithm control path 10 in FIG. 1 and which is incorporated herein. The source image frames 12, 14 are used by the projection generation process 32. The projection process 32 creates the back projection pixel data 16 as would appear at some intermediate time (e.g. N+1/2) from the source image frame (N) 12 with motion compensation vectors. The projection process 32 also creates the front projection pixel data 18 as would appear at the same intermediate time (e.g. N+1/2) from the source image frame (N+1) 14 with motion compensation vectors.

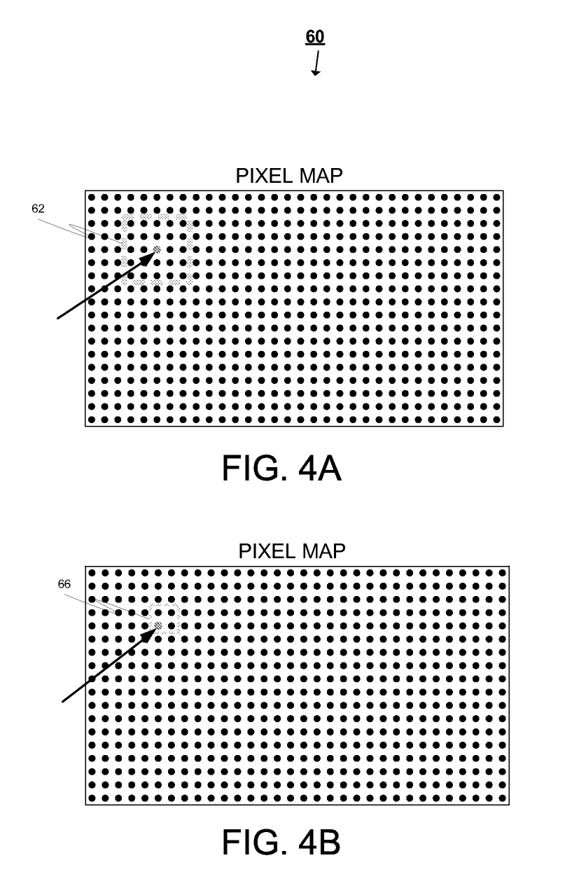

The pixel kernel selection process 34 is configured to select a subset of pixel data from the back and front projection pixel data sets 16, 18 respectively. As noted above, the kernel size depends on a number of factors and the desired quality of the output video. In the exemplary embodiment, the kernel is of a static size. However in alternate embodiments, it can be possible to implement a dynamically changing kernel size based on the error information and the size of error information. The size of the error can be determined by applying simple segmentation of the error surface itself (not the input source image frames). This would allow the system to handle large errors and conserve memory in “good” areas of the estimated vector field. In the present exemplary embodiment, the process 30 starts in the upper left-hand corner of the projections 16, 18 and selects an appropriate kernel around the first pixel. The process 30 cycles through every pixel on the projection pixel data sets 16, 18. The kernel selection process 34 is preferably set up to spatially select a kernel so that the selected pixel is in the center of the kernel. However for pixels at the edge of the image, the pixel would have to be on the edge of the kernel. Kernel selection relative to the selected pixel is shown for both even and odd sized square kernels in FIG. 4. The pixel kernel selection process 34 can select an appropriate pixel kernel from the same spatial location for both the front and back pixel projection data sets 16, 18.

Once the individual front and back pixels 36 and 38 respectively have been selected along with the appropriate surrounding front and back pixel kernels 22, 20 respectively, the front and back kernels 22, 20 are input to the median filter process 24. In the exemplary embodiment the median filter 24 combines the contents of the two kernels into a single list. The median filter 24 generates the average of the two values that are closest to the median of the combined list to be output as the median filter control value 26. The median filter 24 can be a two dimensional filter operation. The median filter control value 26 is used in the determination process 42.

The individually selected front and back pixels 36, 38 from the kernel section process 34 are used in the determination process 42 to determine which of the front pixel 36, back pixel 38 or the average of the two 40, will be output based on the least error difference with the median filter control value 26. As will be appreciated functions could be applied instead of the average pixel value for value 40. For example, a weighted average could be employed in alternative embodiments which could favor the value of one of the front or back projection.

The determination process 42 inputs the median filter control value 26, the front pixel 36, the back pixel 38, and the average pixel value 40. The process 42, calculates three error values as a function of the median filter control value 26. A front error is calculated with the median filter control value 26 and the front pixel 36. A back error is calculated with the median filter control value 26 and the back pixel 38. An average error is calculated with the median filter control value 26 and the average pixel value 40. Finally the process outputs the pixel value that is closest to (least error) the median filter control value 26.

The output pixel 44 is selected from one of the front pixel 36, the back pixel 38, or the average pixel value 40 by the determination process 42 to be output to the video display or appropriate display buffer.

Next, the process 30 determines if the output pixel 44 is from the last spatial position in either the front or back 18, 16 projection data sets. If it is not the last pixel, the process 30 indexes 47 to the next appropriate pixel spatially in the front and back 18, 16 projection data sets and resumes the process again of selecting a kernel for the new selected front and back pixels in the kernel selection process 34. This process 30 repeats until the last pixel to be determined is output. Once the last pixel has been output, thus completing the interpolated image frame, the process moves on to the next image frame to be interpolated 48.

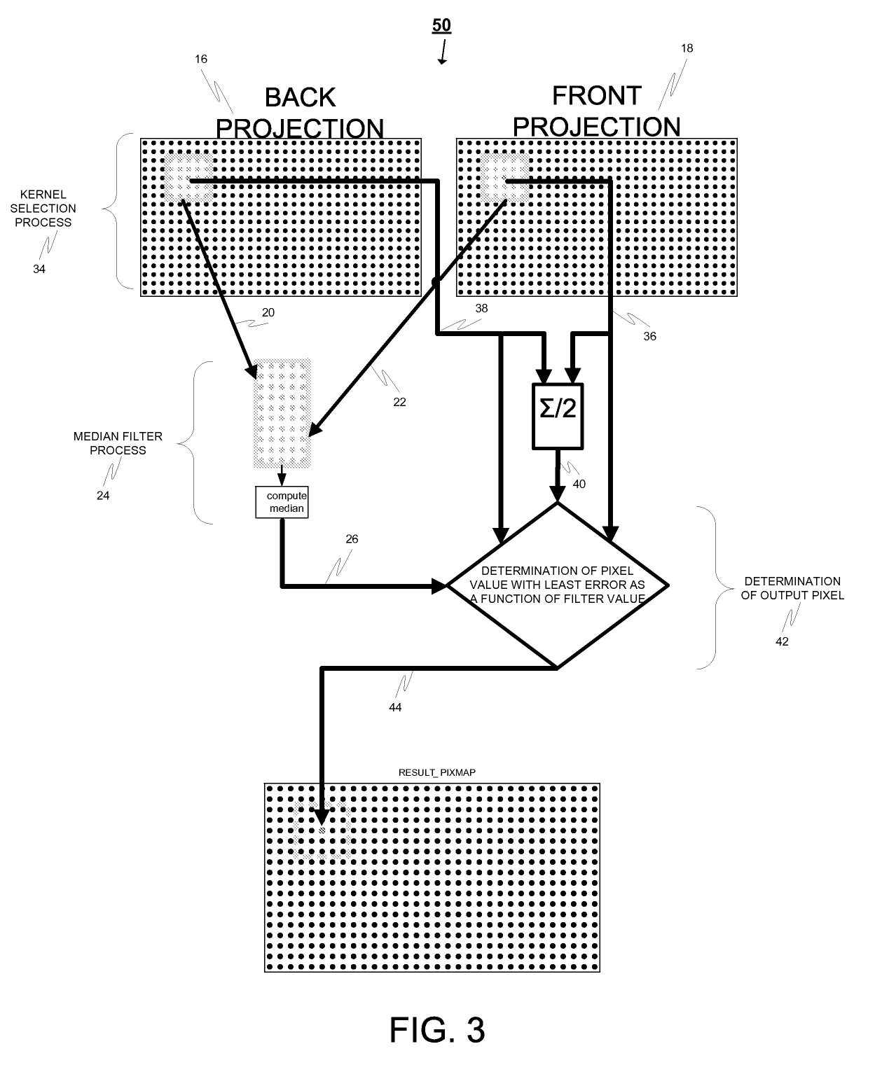

Referring to FIG. 3, with further reference to FIG. 2 an illustration is shown of a halo removal method according to the embodiment shown in FIG. 2. The illustration 50 of the method shown in FIG. 2 includes a back projection pixel map 16, a front projection pixel map 18, a kernel selection process 34, a first kernel of pixels 20, a second kernel of pixels 22, a median filter process 24, a median filter control value 26, a front pixel 36, a back pixel 38, an average pixel value 40, a determination process 42, and a output pixel 44. The illustration 50 shows a portion of the process 30 in FIG. 2, wherein a single output pixel 44 is selected and placed into a resultant output pixel map. The illustration 50 highlights the spatial locations of the first kernel of pixels 20 and second kernel of pixels 22 relative to each other and the selected front and back pixels 36, 38 respectively. The first kernel of pixels 20 can be centered around the selected back pixel 38. The second kernel 22 can be centered around the front pixel 36. The values of the pixels within the first kernel 20 are used by the median filter process 24. The values of the pixels within the second kernel 22 are used by the median filter process 24. The median filter process can be a two dimensional median filter process. The value of the back pixel 38 (also in the first kernel 20) is used by the determination process 42. The value of the front pixel 36 (also in the second kernel 22) is used by the determination process 42. The selected output pixel 44 from the determination process 42 is used to produce the resultant output pixel map.

The illustration also shows the spatial relationship of the output pixel 44 in the resultant pixel map to the first kernel 20, second kernel 22, and the selected front and back pixels 36, 38 respectively. The output pixel 44 is in the same spatial location within an image pixel map as the selected front and back pixels 36, 38.

Referring to FIGS. 4A and 4B, an illustration 60 of exemplary kernel sizes on pixel maps is shown. The illustration 60 shows a 5×5 pixel kernel 62 in the top pixel map. The exemplary 5×5 kernel 62 has an arrow pointing to the center selection pixel. The bottom pixel map shows an exemplary 2×2 kernel 66 with an arrow pointing to the selection pixel in the lower left-hand corner. This illustration 60 is exemplary only and not limiting in the size or shape of the kernels or the location of the selection pixel within the kernels. An even numbered kernel does not have a center pixel and thus there must be a slight offset to the selection pixel as show in the bottom pixel map. The kernel size can be programmable, or selected from a list or table. Also, the horizontal and vertical dimensions of the kernel can be independently programmable or selected from a list or table. Kernel size can be odd (in each dimension), thus giving a center pixel for selection as in the top 5×5 example. Choosing even dimension kernel (per side) would cause ‘phase shift’ (i.e. displacement of high frequency (fine detail) components). If, an even sized 2×2 kernel is used, by convention the output pixel at position (x,y) would be calculated from the kernel of pixels at the following locations as shown in the bottom pixel map, (x, y), (x+1, y), (x, y+1), (x+1, y+1).

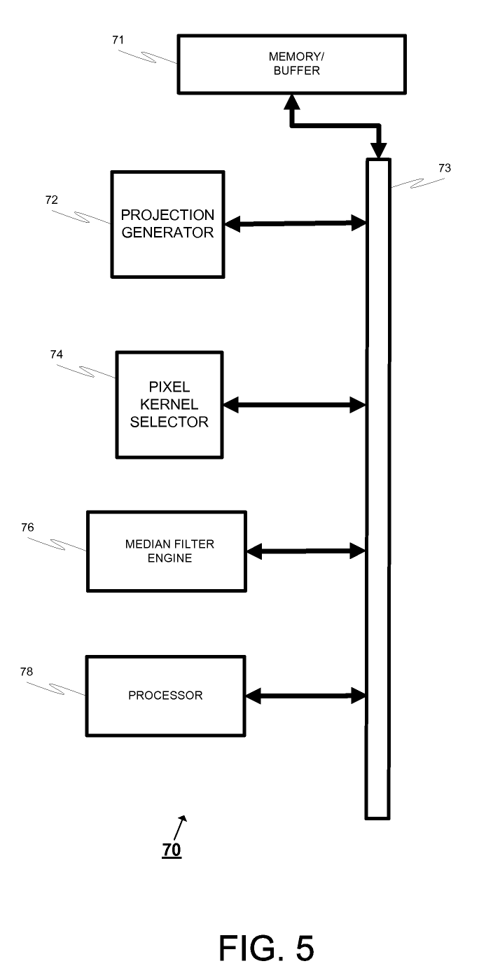

Referring to FIG. 5, an exemplary embodiment of the system 70 includes a memory/buffer 71, a projection generator 72, a communication backbone 73, a pixel kernel sector 74, a median filter engine 76, and a processor 78. The system 70 can be incorporated into a digital signal processor (DSP) integrated circuit chip that performs frame rate conversion for digital video display units.

The memory/buffer 71 can be a standard addressable memory device that is capable of storing at least the two current image frames and other data used by the system. More data can also be stored and retrieved from the memory/buffer 71, such as motion vector data. The memory/buffer 71 can be operatively connected to the communication backbone 73 of the system 70.

The communication backbone 73 can be configured and disposed for the required data traffic of the system 70 between the components. The communication backbone can be operatively connected to each component in the system 70. The communication backbone 73 can be implemented as an internal or external bus, a data-path, a buffer, a shared memory, a network, or equivalent hardware system.

The projection generator 72 is adapted and configured to generate a forward projection pixel map from a first video input frame and generate a backwards projection pixel map from a second video input frame. Both the first and second input video frames are retrieved from the memory/buffer device 71. The projection generator 72 uses the pixel data from each input frame plus the motion vector data for each input frame. The projection generator 72 uses the motion vector data to move the pixels from the input frames to new locations in the front and back projection pixel maps. The projection generator 72 can be operatively connected to the communication backbone 73 of the system. The projection generator 72 is configured to allow it to interact with both the memory/buffer 71, and the pixel kernel selector 74.

The pixel kernel selector 74 is adapted and configured to select a first kernel of pixels from the front projection pixel map and to select a second kernel of pixels from the back projection pixel map that is co-sited with the first kernel. The kernel selector 74 also selects a pixel value from the first and second kernels respectively for use in determining the output pixel in the processor 78. The pixel kernel selector 74 can be operatively connected to the communication backbone 73 of the system. The pixel kernel selector 74 is configured to allow it to interact with the memory/buffer 71, the projection generator 72, and the median filter engine 76.

The median filter engine 76 is adapted and configured to perform median filtering on the first and second kernels and to generate a filter value. The median filter engine 76 can be operatively connected to the communication backbone 73 of the system. The median filter engine 76 can be configured to allow it to interact with the memory/buffer 71, the pixel kernel selector 74, and the processor 78.

The processor 78 is adapted and configured to determine a forward error value as a function of the filter value and a pixel value of the first kernel, a backward error value as a function of the filter value and a pixel value of the second kernel, and an average error value as a function of the filter value and an average pixel value of the selected pixel from the first and second kernels. The processor 78 determines the minimum error value of the three previously determined error values (front, back, and average). The processor 78 selects an output pixel that corresponds to the minimum error value. The processor 78 can be operatively connected to the communication backbone 73 of the system. The processor 78 is configured to allow it to interact with the memory/buffer 71, the median filter engine 76, and the pixel kernel selector 74.

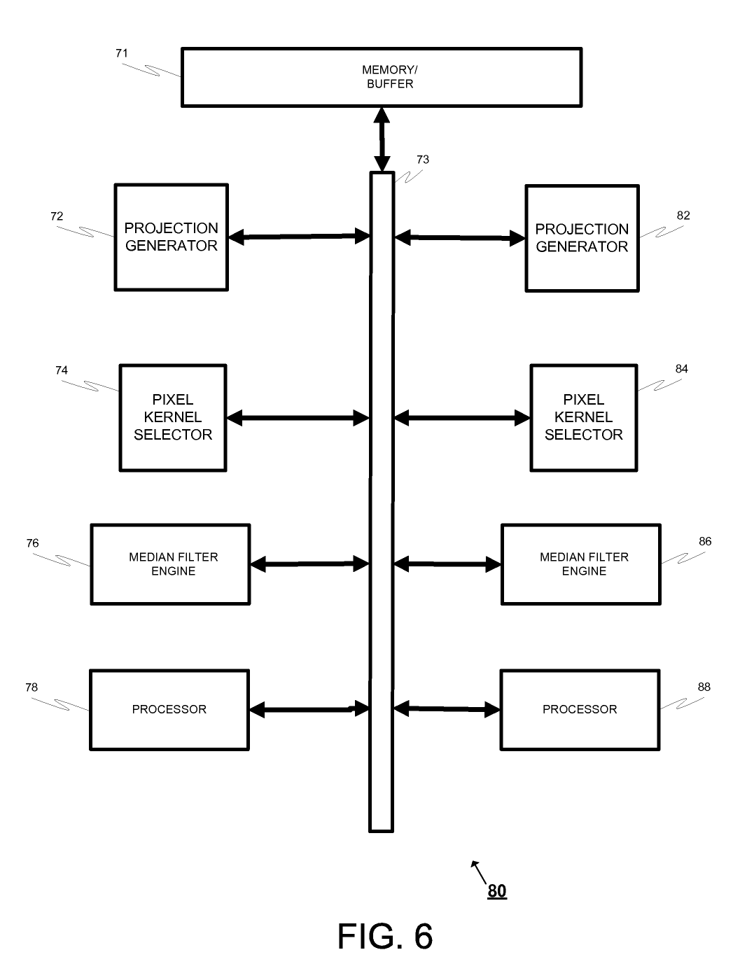

Referring to FIG. 6, a second exemplary embodiment of the system 80 includes a memory/buffer 71, a first projection generator 72, a communication backbone 73, a first pixel kernel sector 74, a first median filter engine 76, a first processor 78, a second projection generator 82, a second pixel kernel selector 84, a second median filter engine 86, and a second processor 88. The system 80 can be incorporated into a digital signal processor (DSP) integrated circuit chip that performs frame rate conversion for digital video display units.

The system may include a second set of projection generator 82, pixel kernel selector 84, median filter engine 86, and processor 88 operatively connected to the communication backbone 73 as compared to the system 70 in FIG. 5. The second set of components can be configured and disposed to allow the system 80 to process the two interpolated frames in parallel.

In addition to hardware implementations of devices that are for performing frame rate conversion on pixel data in accordance with an embodiment of the present invention such devices may also be embodied in software disposed, for example, in a computer usable (e.g., readable) medium configured to store the software (e.g., a computer readable program code). The program code causes the enablement of embodiments of the present invention, including the following embodiments: (i) the functions of the systems and methods disclosed herein (such as systems and methods for performing frame rate conversion of a video signal including a plurality of video frames); (ii) the fabrication of the systems and methods disclosed herein (such as the fabrication of devices that are enabled to perform frame rate conversion of a video signal including a plurality of video frames); or (iii) a combination of the functions and fabrication of the systems and methods disclosed herein.

For example, this can be accomplished through the use of general programming languages (such as C or C++), hardware description languages (HDL) including Verilog, Verilog-A, HDL, VHDL, Altera HDL (AHDL) and so on, or other available programming and/or schematic capture tools (such as circuit capture tools). The program code can be disposed in any known computer usable medium including semiconductor, magnetic disk, optical disk (such as CD-ROM, DVD-ROM) and as a computer data signal embodied in a computer usable (e.g., readable) transmission medium (such as a carrier wave or any other medium including digital, optical, or analog-based medium). As such, the code can be transmitted over communication networks including the Internet and internets. It is understood that the functions accomplished and/or structure provided by the systems and techniques described above can be represented in a core (such as a media processing core) that is embodied in program code and may be transformed to hardware as part of the production of integrated circuits.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system for performing frame rate conversion of a video signal including a plurality of video frames, the system comprising:
at least one projection generator adapted and configured to generate a forward projection pixel map from a first video frame and generate a backwards projection pixel map from a second video frame;
a pixel kernel selector adapted and configured to select a first kernel of pixels from the forward projection pixel map and to select a second kernel of pixels from the backwards projection pixel map that is co-sited with the first kernel;
a median filter engine adapted and configured to perform median filtering on the first and second pixel kernels and to generate a filter value; and
a processor adapted and configured to determine:
a forward error value as a function of the filter value and a pixel value of the first kernel;
a backward error value as a function of the filter value and a pixel value of the second kernel; and
an average error value as a function of the filter value and an average pixel value of the first and second kernels;
wherein the processor is further configured to:
determine the minimum error value of the group of the forward error value, the backward error value, and the average error value; and
select an output pixel value that corresponds to the minimum error value.

2. The system of claim 1 wherein the at least one projection generator comprises a first projection generator configured to generate a forward projection pixel map from a first video frame and a second projection generator configured to generate a backwards projection pixel map from a second video frame.

3. The system of claim 1 wherein the median filter engine is further configured to perform two dimensional median filtering on the first and second pixel kernels.

4. The system of claim 1 wherein the pixel value of the first kernel comprises the center pixel of the first kernel and the pixel value of the second kernel comprises the center pixel of the second kernel.

5. The system of claim 1 comprising computer readable media storing instructions in a hardware description language software.

6. The system of claim 5, wherein the instructions comprise at least one of: Verilog hardware description language software, Verilog-A hardware description language software, and VHDL hardware description language software.

7. A method for performing frame rate conversion of a video signal including a plurality of video frames, the method comprising:
generating a forward projection pixel map from a first video frame;
generating a backwards projection pixel map from a second video frame;
selecting a first kernel of pixels in the forward projection pixel map;
selecting a second kernel of pixels in the backward projection pixel map that is co-located with the first kernel;
implementing a rank-order filter to the first and second kernels and generating a filter value;
determining a forward error value as a function of the filter value and a pixel value from the first kernel;
determining a backward error value as a function of the filter value and a pixel value from the second kernel;
determining an average error value as a function of the filter value and an average pixel value from the first and second kernel;
determining the minimum error value of the group of the forward error value, the backward error value, and the average error value; and
outputting the pixel value that corresponds to the minimum error value.

8. The method of claim 7 wherein implementing a rank-order filter includes implementing a two dimensional median filter.

9. The method of claim 7 wherein the pixel value of the first kernel comprises the center pixel of the first kernel and the pixel value of the second kernel comprises the center pixel of the second kernel.

10. A computer readable media storing instructions, said instructions when executed are adapted to:
generate a forward projection pixel map from a first video frame;
generate a backwards projection pixel map from a second video frame;
select a first kernel of pixels in the forward projection pixel map;
select a second kernel of pixels in the backward projection pixel map that is co-located with the first kernel;
implement a rank-order filter to the first and second kernels and generating a filter value;
determine a forward error value as a function of the filter value and a pixel value from the first kernel;
determine a backward error value as a function of the filter value and a pixel value from the second kernel;
determine an average error value as a function of the filter value and an average pixel value from the first and second kernel;
determine the minimum error value of the group of the forward error value, the backward error value, and the average error value; and
output the pixel value that corresponds to the minimum error value.

11. The system of claim 10 wherein said instructions comprise instructions in a hardware description language software.

12. The system of claim 11, wherein the instructions in a hardware description language comprise at least one of: Verilog hardware description language software, Verilog-A hardware description language software, and VHDL hardware description language software.

13. A system for performing frame rate conversion of a video signal including a plurality of video frames, the system comprising:
a median filter engine to perform median filtering on first and second pixel kernels and to generate a filter value, said first kernel pixels selected from a forward projection pixel map based on a first video frame and said second kernel of pixels selected from a backwards projection pixel map that is co-sited with the first kernel and the backwards projection pixel map based on a second video frame; and
a processor to select an output pixel value based on a minimum error value generated from said filter value, pixel values of said first and second kernels.

14. The system of claim 13 wherein the median filter engine is further configured to perform two dimensional median filtering on the first and second pixel kernels.

15. The system of claim 13 wherein the pixel value of the first kernel comprises the center pixel of the first kernel and the pixel value of the second kernel comprises the center pixel of the second kernel.

16. The system of claim 13 comprising computer readable media storing instructions in a hardware description language software.

17. The system of claim 16, wherein the instructions comprise at least one of: Verilog hardware description language software, Verilog-A hardware description language software, and VHDL hardware description language software.

18. A method of performing frame rate conversion of a video signal including a plurality of video frames, the method comprising;
generating a filter value based on a spatial selection of corresponding pixels in first and second projections, said first projection corresponding at least in part on a motion compensated frame for an intermediate time generated from a first frame, said second projection corresponding at least in part on a motion compensated frame for said intermediate time generated from a second frame,
generating a pixel value from one of: a first pixel in said first projection, a second pixel in said second projection, or a combination of the first and second pixels, said generating based in part on said filter value.

19. The method of claim 18 wherein generating a filter value includes implementing a two dimensional median filter.

20. The method of claim 18 wherein the first pixel of said first projection comprises a center pixel of the spatial selection in said first projection and the second pixel of said second projection comprises a center pixel of the spatial selection in said second projection.
